(19) United States
(12) Patent Application Publication
(10) Pub. No.: US 2016/0088193 A1
(43) Pub. Date: Mar. 24, 2016

(54) OUTPUT PROCESSING SYSTEM, OUTPUT PROCESSING DEVICE, AND NON-TRANSITORY COMPUTER-READABLE RECORDING MEDIUM

(71) Applicant: FUJI XEROX CO., LTD., Tokyo (JP)

(72) Inventor: Ryuichi ISHIZUKA, Kanagawa (JP)

(73) Assignee: FUJI XEROX CO., LTD., Tokyo (JP)

(21) Appl. No.: 14/626,970

(22) Filed: Feb. 20, 2015

(30) Foreign Application Priority Data
Sep. 19, 2014 (JP) 2014-190894

(51) Int. Cl. H04N 1/60

(52) U.S. Cl. CPC H04N 1/6016; H04N 1/6008; H04N 1/6097; H04N 1/603

(57) ABSTRACT

An output processing system includes a source device and a destination device. The source device transfers output information created in anticipation of a target output device in an output color space whose components are colors of color material, together with target device property information indicating characteristics of the target output device. The destination device receives the output information and the target device property information transferred from the source device, creates color conversion information from the target device property information and actual device property information indicating characteristics of the destination device itself, and conducts color conversion of the output information.

### CROSS-REFERENCE TO RELATED APPLICATIONS

This application is based on and claims priority under 35 USC 119 from Japanese Patent Application No. 2014-190894 filed Sep. 19, 2014.

### BACKGROUND

### Technical Field

The present invention relates to an output processing system, an output processing device, and a non-transitory computer-readable recording medium.

### SUMMARY

According to an aspect of the invention, there is provided an output processing system that includes a source device and a destination device. The source device transfers output information created in anticipation of a target output device in an output color space whose components are colors of color material, together with target device property information indicating characteristics of the target output device. The destination device receives the output information and the target device property information transferred from the source device, creates color conversion information from the target device property information and actual device property information indicating characteristics of the destination device itself, and conducts color conversion of the output information.

### BRIEF DESCRIPTION OF THE DRAWINGS

Exemplary embodiments of the present invention will be described in detail based on the following figures, wherein:

FIG. 1 is a configuration diagram illustrating a first exemplary embodiment of the present invention;

FIG. 2 is a flowchart illustrating an example of operation of a destination device according to a first exemplary embodiment of the present invention;

FIG. 3 is a flowchart illustrating another example of operation of a destination device according to a first exemplary embodiment of the present invention;

FIG. 4 is a configuration diagram illustrating a second exemplary modification of the first exemplary embodiment of the present invention;

FIG. 5 is a configuration diagram illustrating a second exemplary embodiment of the present invention;

FIG. 6 is a flowchart illustrating an example of operation of an actual output device according to the second exemplary embodiment of the present invention; and

FIG. 7 is an explanatory diagram illustrating an example of a computer program, a recording medium storing the program, and a computer in the case of using a computer program to realize the functions of a device described in the exemplary embodiments of the present invention.

### DETAILED DESCRIPTION

Generally, color reproduction characteristics differ by each device model, or even by each individual device in some cases. Even for a single output device, the color reproduction characteristics may differ in some cases if the configuration is changed by purchasing and installing an expansion board for that output device, for example. Consequently, even if queued output information is transferred to another output device, if color conversion information compatible with the target output device does not exist on the destination device, output reproducing the color characteristics of the target output device may not be obtained. Also, if color conversion information corresponding to the color reproduction characteristics after a configuration change does not exist, output reproducing the color characteristics of the target output device after a configuration change may not be obtained.

In this way, recreating color conversion information is a conceivable way to address the above issue when color conversion information does not exist on a new output device or a new configuration. For example, if the information to be output is information using the RGB color space or the CIELAB color space, it is sufficient to recreate color conversion information using a model proposed by the International Color Consortium (ICC), which is a commonly used color conversion method.

When creating color conversion information for an output color space whose components are the colors of the color material used by an output device, raw data made up of CIELAB values and CMYK values indicating the characteristics of the target output device, and raw data made up of CIELAB values and CMYK values indicating the characteristics of the output device that actually outputs may be used. The information used to create color conversion information is not limited to raw data, but the information used to create the color conversion information may be discarded after the color conversion information is created, and thus does not depend on the output device. Consequently, when recreating color conversion information, such as in the case of attempting to output from another output device or in the case of a configuration change in the output device as discussed earlier, information such as the characteristics of the target output information is searched for, and operations to configure various settings for creating color conversion information are performed. Such operations are burdensome for the user to perform, mistaken operations may occur, and such operations or trial-and-error operations by the user may be time-consuming. The present invention was devised in light of such circumstances.

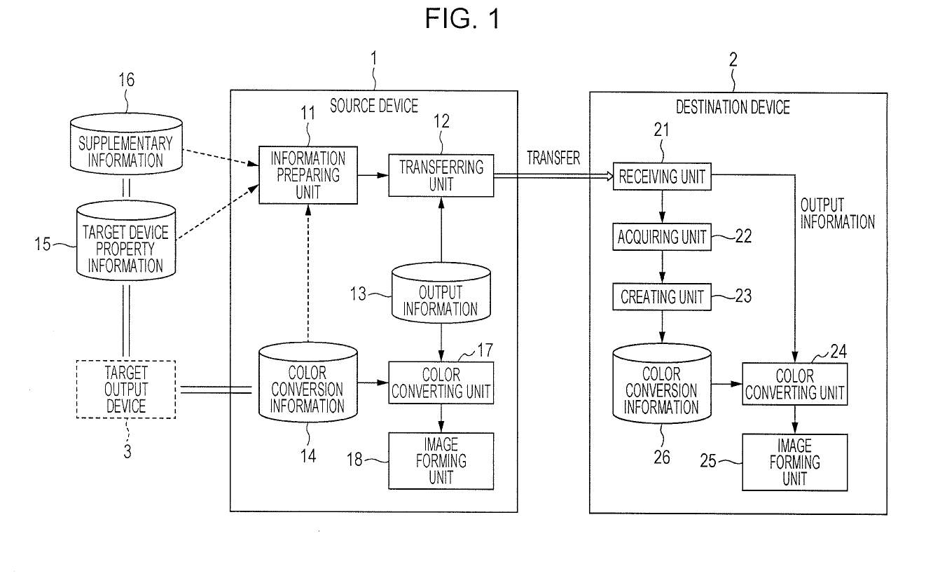

FIG. 1 is a configuration diagram illustrating a first exemplary embodiment of the present invention. FIG. 1 illustrates a source device 1, a destination device 2, a target output device 3, an information preparing unit 11, a transferring unit 12, output information 13, color conversion information 14, target device property information 15, supplementary information 16, a color converting unit 17, an image forming unit 18, a receiving unit 21, an acquiring unit 22, a creating unit 23, a color converting unit 24, an image forming unit 25, and color conversion information 26.

One or multiple pieces of output information 13 scheduled for output on the source device 1 are queued in the source device 1. Each piece of output information 13 is created in anticipation of being output on the target output device 3, and is color information in an output color space whose components are the colors of the color material used by the target output device 3. For example, if the target output device 3 is a device that outputs a color image using C, M, Y, and K color material, the output information 13 is created as a color image in the CMYK color space so that the target output device 3 produces the intended color reproduction. Obviously, the output color space is not limited to the CMYK color space. As an example, in the case of a device that uses color material for four colors other than C, M, Y, and K, or for five or more colors including special colors, the output information 13 becomes information in a color space having four, or five or more, dimensions whose components are the colors of the relevant color material.

In the output information 13, the anticipated target output device 3 is specified, and in the source device 1, color conversion information 14 corresponding to the specified target output device 3 is used for color conversion of the output information 13 by the color converting unit 17 and output by the image forming unit 18, thereby realizing the color reproduction of the target output device 3 with the source device 1. The color conversion information 14 corresponding to the target output device 3 refers to color conversion information 14 that is selected in accordance with the target output device 3 and various configuration conditions and the like, and the term color conversion information 14 will be used in this sense hereinafter.

The color conversion information 14 is information used when conducting color conversion to realize the color reproduction of the target output device 3 with the source device 1, and is created in advance from the target device property information 15, which is information about the output characteristics of the target output device 3, and information about the output characteristics of the source device 1, using an established method. The color conversion process conducted using the color conversion information 14 is color conversion in an output color space whose components are the colors of color material. For example, if the output information is information in the CMYK color space and the source device 1 is a device that uses CMYK color material, color conversion from the CMYK color space to the CMYK color space is conducted. This conversion typically includes control of color material quantity. For example, various techniques such as controlling the conservation of K are factored in, and color reproduction is realized in addition to factors such as the feel of the material, luster, and countermeasures against bleeding and blur, so that color conversion enabling output by the target output device 3 to be reproduced with the source device 1 is conducted. Consequently, the color conversion information 14 depends on the characteristics of the target output device 3 and the source device 1, and in general, using the output information 13 to conduct color conversion on another device may not result in the color reproduction of the target output device 3.

Although discussed earlier, the color conversion information 14 is created from the target device property information 15 and information about the output characteristics of the source device 1, but is created in advance since the creation is time-consuming. Consequently, it is sufficient for the color conversion information 14 to exist when the color converting unit 17 conducts color conversion of the output information 13. Information such as the target device property information 15 and information about the output characteristics of the source device 1 may be omitted during color conversion, and is not saved in some cases. In the present exemplary embodiment, the target device property information 15 and various other information used to create the color conversion information 14 is saved as the supplementary information 16. This information is not limited to being saved on the source device 1, and may also be saved on another device or registered in another database or the like. In this case, suppose that information used to access the relevant information, such as URL information specifying another device where the relevant information is being stored, for example, is saved in the source device 1.

The output information 13 given to the source device 1 is subjected to a color conversion process by the color converting unit 17 using color conversion information 14 corresponding to the target output device 3 anticipated by that output information 13, and is output by the image forming unit 18. However, output on the source device 1 may be unavailable in some cases, such as when the source device 1 malfunctions, when outputting on another device, or when changing to output on another device because of an output queue or other reason. In this case, the output information 13 is transferred and output by another device. FIG. 1 illustrates a case of transferring the output information 13 to a destination device 2 for output.

The source device 1 includes an information preparing unit 11 and a transferring unit 12 as a configuration used to transfer the output information 13. The information preparing unit 11 prepares target device property information 15 indicating the characteristics of the target output device 3. The information preparing unit 11 may also prepare various supplementary information 16 used together with the target device property information 15 when creating the color conversion information 14. The supplementary information 16 may be various information, such as various configuration information, including a paper color correction method, a gamut compression scheme, and quantity restrictions on color materials such as toner and ink, as well as output method properties, paper properties, and model information or unique information of the source device 1, for example. Furthermore, although discussed later in an exemplary modification, color conversion information 14 corresponding to a target output device 3 provided in the source device 1 may also be prepared. Additionally, information such as intermediate data created during the process of creating the color conversion information 14, and a forward prediction model and reverse prediction model created from the target device property information 15, or an ICC profile created from the target device property information 15, for example, may also be prepared. The various information may be prepared as the information itself, or prepared as information used to access the various information.

Various information including the transferring unit 12, the output information 13, and the target device property information 15 prepared by the information preparing unit 11, and various information existing in the source device 1, is transferred to the destination device 2. The information other than the output information 13, such as the target device property information 15 and the supplementary information 16, may be transferred as the information itself, or transferred as information used to access the various information.

The destination device 2 likewise includes the functions of conducting color conversion on supplied output information with the color converting unit 24 using color conversion information 26 corresponding to the anticipated target output device, and outputting with the image forming unit 25. When the output information 13 is transferred from the source device 1, if color conversion information 26 corresponding to the target output device 3 anticipated by the output information 13 is available, that color conversion information 26 may be used. However, if color conversion information 26 corresponding to the target output device 3 anticipated by the output information 13 transferred from the source device 1 does not exist, the color reproduction of the target output device 3 is not conducted on the destination device 2. Consequently, color conversion information 26 corresponding to the target output device 3 is created again on the destination device 2.

As discussed earlier, creation of the color conversion information 26 uses target device property information 15 indicating the output characteristics of the target output device 3, information indicating the output characteristics of the destination device 2, and optionally various configuration information. However, the color conversion information 26 is created in advance, and in some cases, the output of output information 13 corresponding to the target output device 3 is not anticipated, or information such as the target device property information 15 and the various configuration information does not exist on the destination device 2.

To accommodate such cases, the source device 1 transfers the output information 13, and additionally transfers the target device property information 15, and optionally supplementary information 16. The destination device 2 includes a receiving unit 21, an acquiring unit 22, and a creating unit 23 as a configuration that receives the above information and recreates the color conversion information 26. The receiving unit 21 receives various information transferred from the source device 1.

The acquiring unit 22 acquires the output information 13 and target device property information 15, and optionally supplementary information 16, transferred from the source device 1. If the target device property information 15 and the supplementary information 16 are transferred as the information itself, it is sufficient to receive the transfer of the information. On the other hand, if information used to access the target device property information 15 and the supplementary information 16 is transferred, the transferred information may be used to access the target device property information 15 and the supplementary information 16. This information may exist on the source device 1, but may also exist on another device. For example, the information may be configured in a database, and acquired by searching the database.

The creating unit 23 uses target device property information acquired by the acquiring unit 22, actual device property information indicating the output characteristics of the current device (destination device 2), and optionally supplementary information 16 acquired by the acquiring unit 22, and creates color conversion information 26 corresponding to the target output device 3 anticipated by the output information 13 received by the receiving unit 21, in accordance with information such as configuration information in the destination device 2. The output information 13 is created in an output color space whose components are the colors of color material used by the target output device, and the color conversion information 26 used to conduct color conversion is created in this output color space. Also, the created color conversion information 26 is used in the color conversion by the color converting unit 24 so that the color reproduction of the target output device 3 is conducted with the destination device 2.

Note that in the case of using the transferred supplementary information 16, the supplementary information 16 may be used as-is, or the supplementary information 16 may be modified in accordance with configuration information of the destination device 2, and converted to information compatible with the circumstances for use. Conversely, the settings of the destination device 2 may also be modified in accordance with the supplementary information 16 in some cases. When creating the color conversion information 26, the color conversion information 26 may be made to reflect not only color reproduction, but also various settings such as color material bleed adjustment and color material quantity correction dependent on the destination device 2.

Also, in the case of additionally receiving information such as intermediate data created during the process of creating the color conversion information 14 on the source device 1, and a forward prediction model and reverse prediction model created from the target device property information 15, or an ICC profile created from the target device property information 15, for example, this information may also be used. In the case of using such information, the time and processing load for creating the color conversion information 26 may be reduced compared to the case of not using such information.

Various established methods may be used as the method of creating the color conversion information 26, insofar as the method creates color conversion information 26 enabling the color reproduction of the target output device 3 to be conducted on the destination device 2. As an example, if the color space of the colors of the color material is the CMYK color space, color conversion information 26 that controls K, such as conserving K, for example, and conducts color conversion from the CMYK color space to the CMYK color space may be created. Obviously, the color conversion information 26 may be created according to the supplementary information 16 and various configured conditions. For example, various conditions may be imposed, such as control of the total quantity of color material, control of a specific color, and bleed control, for example, and the color conversion information 26 may be created in accordance with these conditions. Since the device that actually outputs is the destination device 2 that differs from the source device 1, the color conversion information 26 created by the creating unit 23 may differ from the color conversion information 14 provided in the source device 1 in some cases.

After the creating unit 23 creates the color conversion information 26, the color conversion information 26 is used by the color converting unit 24 to conduct color conversion on the transferred output information 13, and the converted output information is output by the image forming unit 25.

The color conversion information 26 created by the creating unit 23 may be saved in association with the target output device 3. After the color conversion information 26 is created, if output information 13 anticipating the target output device 3 is transferred, the already-created color conversion information 26 may be used to conduct color conversion.

Next, an example of operation according to the configuration discussed above will be described. At this point, suppose that queued output information 13 to be output on the source device 1 is made to be output from the destination device 2. On the source device 1, the information preparing unit 11 prepares the target device property information 15 indicating the characteristics of the target output device 3, and optionally various supplementary information 16 such as configuration information and device-related information used together with the target device property information 15 to create the color conversion information 14. This target device property information 15 and optionally the supplementary information 16 and the like is transferred together with the output information 13 from the transferring unit 12 to the destination device 2. The transfer may be the transfer of the various information itself, or the transfer of information used to access the various information.

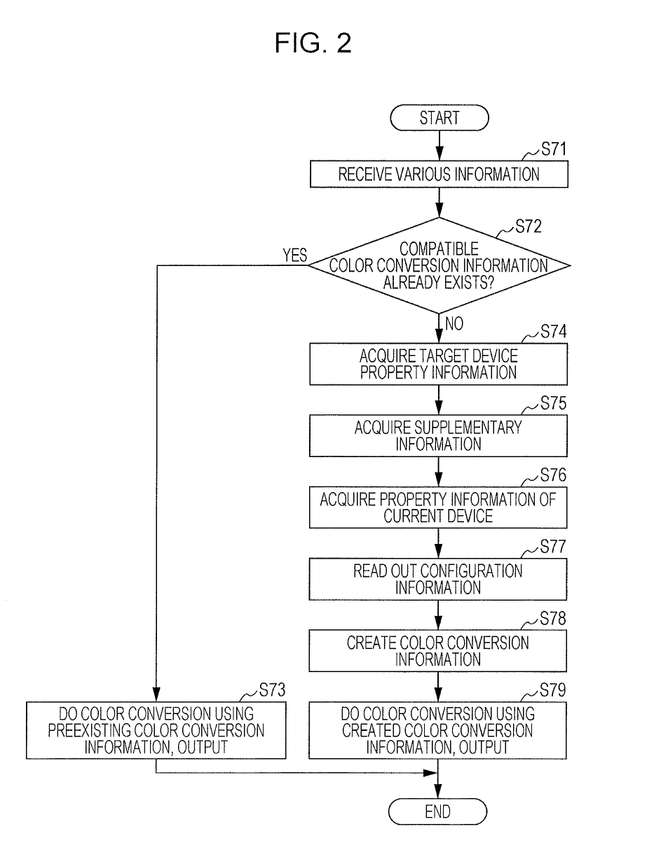

FIG. 2 is a flowchart illustrating an example of operation of a destination device according to a first exemplary embodiment of the present invention. After the output information 13, the target device property information 15, and optionally the various supplementary information 16 and the like, is transferred from the source device 1, in S71, the receiving unit 21 receives this information.

In S72, it is determined whether or not color conversion information 26 corresponding to the target output device 3 anticipated by the received output information 13 already exists on the current device (destination device 2). Obviously, since the color conversion information 26 may also differ depending on various configured conditions, such configured conditions are taken into account to judge whether or not to use already-existing color conversion information 26 corresponding to the target output device 3.

If color conversion information 26 that corresponds to the target output device 3, including configured conditions and the like, already exists, in S73, the existing color conversion information 26 corresponding to the target output device 3 is used by the color converting unit 24 to conduct color conversion, and the converted output information is output from the image forming unit 25. The process of creating the color conversion information 26 may be reduced or omitted in some cases, such as when the color reproduction of the target output device 3 is already anticipated on the destination device 2, or when output information 13 previously transferred from the source device 1 anticipated the target output device 3 and color conversion information 26 was already created.

If it is determined in S72 that color conversion information 26 corresponding to the target output device 3 anticipated by the output information 13 does not exist, in S74, the acquiring unit 22 acquires the transferred target device property information 15. If the target device property information 15 is transferred as information used to access the target device property information 15, the target device property information 15 is acquired on the basis of that information. Also, if the supplementary information 16 is transferred, in S75 the supplementary information 16 is additionally acquired. Likewise, if the supplementary information 16 is transferred as information used to access the supplementary information 16, the supplementary information 16 is acquired on the basis of that information.

Additionally, in S76 the output characteristics of the current device (destination device 2) are acquired, and in S77, various configuration information is read out, such as information about total quantities of color material, for example. After this information is collected, in S78, the creating unit 23 creates the color conversion information 26. The created color conversion information 26 is used to conduct color conversion so that the output characteristics of the target output device 3 are reproduced with the current device (destination device 2). Note that transferred supplementary information 16 may also be used when creating the color conversion information 26 in S78. In this case, the supplementary information 16 may be modified in accordance with the configuration information of the destination device 2 read out in S77, and converted to information compatible with the circumstances for use.

In S79, the color converting unit 24 uses the color conversion information 26 created in S78 to conduct color conversion, and the converted output information may be output from the image forming unit 25. In the case of output, the output settings may be modified in accordance with supplementary information 16 transferred from the source device 1.

During the process of transferring and outputting output information 13 queued in the source device 1 on the destination device 2 discussed above, the user does not perform any work such as preparing the target device property information 15 or reconfiguring the target output device 3. In addition, mistaken operations and the like that may be produced by such work do not occur.

A first exemplary modification of the first exemplary embodiment of the present invention will be described. In the above description, the color conversion information 14 provided in the source device 1 is not used in the destination device 2. However, in some cases the color conversion information 14 provided in the source device 1 may be used under certain conditions, and in such cases, the creation of new color conversion information 26 may be omitted.

To accommodate such cases, first, when transferring output information 13 on the source device 1, color conversion information 14 corresponding to the target output device 3 anticipated by the output information 13 is also transferred to the destination device 2. At the destination device 2, the transferred color conversion information 14 is received together with the output information 13, and it is judged whether or not the received color conversion information 14 is compatible with the current device (destination device 2) and may be used.

For example, if the source device 1 and the destination device 2 share a common device model, the characteristics of the target output device 3 may still be reproduced within an acceptable range even if the color conversion information 14 of the source device 1 is used for output on the destination device 2. In addition, if the output characteristics of the source device 1 are additionally transferred to the destination device 2, and the difference between the output characteristics of the source device 1 and the output characteristics of the destination device 2 are within a predetermined range, the characteristics of the target output device 3 may still be reproduced within an acceptable range even if the color conversion information 14 of the source device 1 is used for output on the destination device 2.

If it is judged that the color conversion information 14 transferred from the source device 1 is compatible with the current device (destination device 2) and may also be used on the destination device 2, color conversion may be conducted using the color conversion information 14, and the converted output information may be output. If it is judged that the color conversion information 14 is not compatible with the current device (destination device 2) and is not to be used, color conversion information 26 may be created as discussed earlier, and color conversion and output may be conducted.

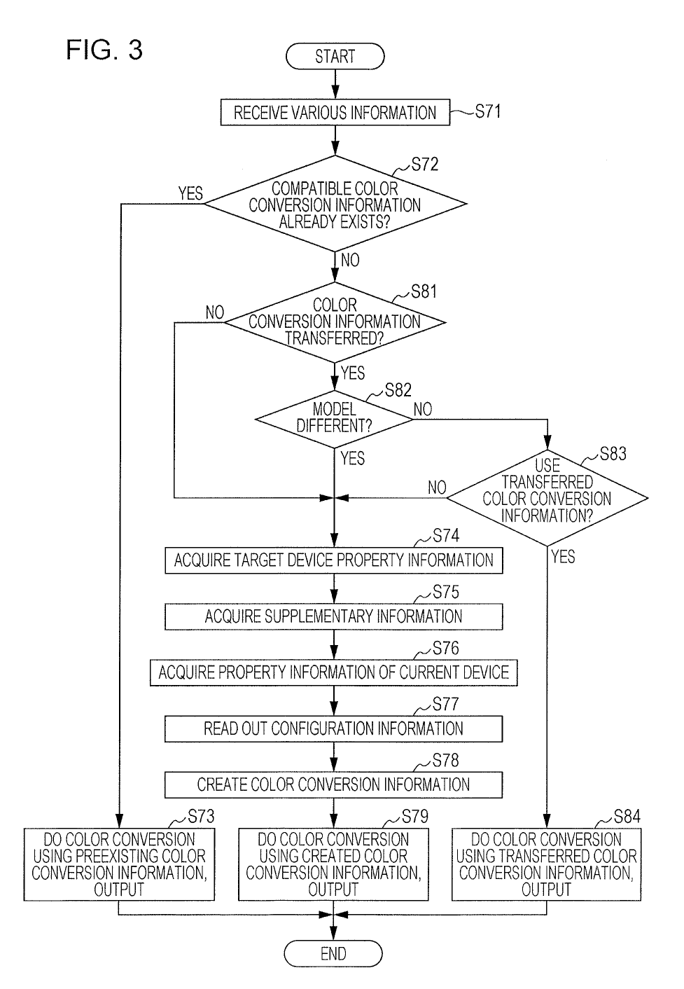

FIG. 3 is a flowchart illustrating another example of operation of a destination device according to a first exemplary embodiment of the present invention. FIG. 3 illustrates an example of operation in the case in which information related to the device model is transferred to the supplementary information 16, and the information related to the device model is used to judge whether or not to use the transferred color conversion information 14. Note that processes already described in FIG. 2 are designated with the signs used in FIG. 2, and duplicate description thereof may be reduced or omitted.

The source device 1 transfers the output information 13, the target device property information 15, and optionally the supplementary information 16 and the like, together with the color conversion information 14 corresponding to the target output device 3 anticipated by the output information 13, to the destination device 2. At the destination device 2, in S71 the receiving unit 21 receives this information. In S72, it is determined whether or not color conversion information 26 corresponding to the target output device 3 anticipated by the received output information 13 already exists on the current device (destination device 2). If corresponding color conversion information 26 already exists, in S73, the existing color conversion information 26 corresponding to the target output device 3 is used by the color converting unit 24 to conduct color conversion, and the converted output information is output from the image forming unit 25.

If it is determined in S72 that color conversion information 26 corresponding to the target output device 3 anticipated by the output information 13 does not exist, in S81, it is determined whether or not color conversion information 14 was transferred. If color conversion information 14 was not transferred, the process proceeds to S74, and in the processing from S74 to S79, color conversion information 26 is created, color conversion is conducted, and the converted output information is output.

If color conversion information 14 was transferred, in S82 the device model of the source device 1 is determined from the transferred supplementary information 16. The determination of device model is not limited to determining whether or not the model name is the same or different, and may also judge from the device serial number whether or not the characteristics are in a group of predetermined range, or determine whether or not the devices are included in a characteristics group if the device models differ but the characteristics are within a predetermined range. If the device model determination determines that the source device 1 and the destination device 2 are different, the processes treats the color conversion information 14 as being incompatible with the current device (destination device 2) and proceeds to S74, and in the processing from S74 to S79, color conversion information 26 is created, color conversion is conducted, and the converted output information is output.

If the device model determination determines that the source device 1 and the destination device 2 have a commonality, in this example of operation, in S83 it is additionally determined whether or not to use the transferred color conversion information 14. This determination may obey a preconfigured setting, for example. If the destination device 2 is configured to not use the transferred color conversion information 14, the process proceeds to S74, and in the processing from S74 to S79, color conversion information 26 is created, color conversion is conducted, and the converted output information is output. If the destination device 2 is configured to use the transferred color conversion information 14, in S84, the color conversion information 14 may be used by the color converting unit 24 to conduct color conversion, and the converted output information may be output by the image forming unit 25. In the case of using the transferred color conversion information 14, the creation of new color conversion information 26 on the destination device 2 may be conducted, or the creation process may be reduced or omitted.

Herein, the device models of the source device 1 and the destination device 2 are compared, but it may also be determined whether or not the difference between the output characteristics of the source device 1 and the output characteristics of the destination device 2 is within a predetermined range as discussed above, for example. In this case, source device property information indicating the output characteristics of the source device 1 may also be transferred from the source device 1, and the destination device 2 may additionally receive the source device property information. Subsequently, in S82 it is determined whether or not the difference between the output characteristics of the source device 1 indicated by the source device property information and the output characteristics of the current device (destination device 2) is within a predetermined range. If the difference in output characteristics is within a predetermined range, the process proceeds to S83, and if the destination device 2 is configured to use the color conversion information 14, the transferred color conversion information 14 is used to conduct color conversion information, and the converted output information is output. Meanwhile, if the difference in output characteristics is not within a predetermined range, or if the destination device 2 is not configured to use the color conversion information 14, the creation of color conversion information 26, the color conversion, and the output in the processing from S74 to S79 may be conducted.

Obviously, both of the device model comparison and the output characteristics comparison may be conducted, or a determination that additionally accounts for other conditions may be conducted.

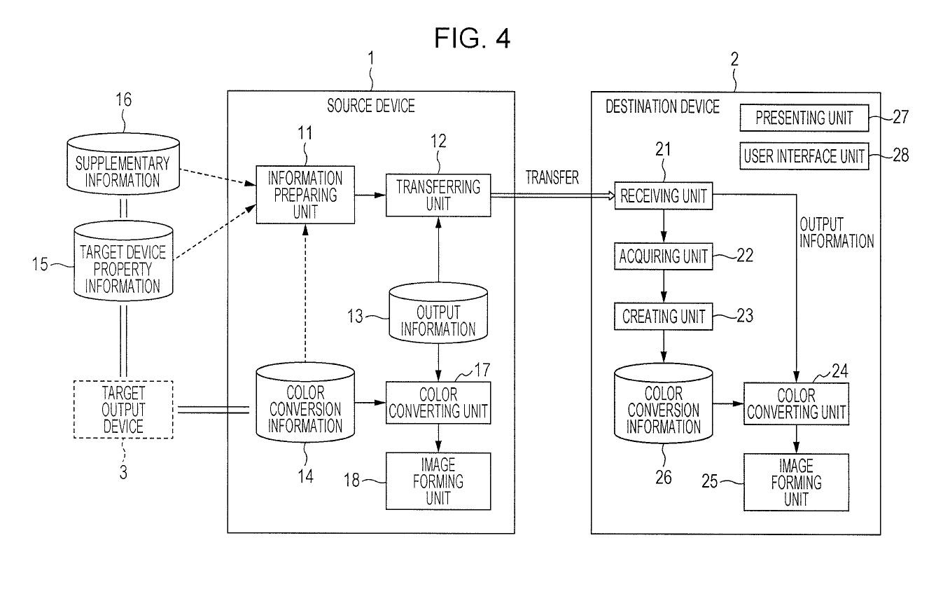

A second exemplary modification of the first exemplary embodiment of the present invention will be described. FIG. 4 is a configuration diagram illustrating a second exemplary modification of the first exemplary embodiment of the present invention. FIG. 4 illustrates a presenting unit 27 and a user interface unit 28. The second exemplary modification illustrates a configuration in which the user makes the judgment of whether or not to use the transferred color conversion information 14 in S83 of the example of operation illustrated in FIG. 3 according to the first exemplary modification discussed above.

The presenting unit 27 presents the user with information used by the user to judge whether to use the transferred color conversion information 14, or create new color conversion information 26. For example, information about the difference between the output characteristics of the source device 1 indicated by the transferred source device property information and the output characteristics of the current device (destination device 2) is presented to the user. Obviously, various information relevant to the user making a judgment may be presented to the user.

The user interface unit 28 receives an instruction from the user. Herein, the user interface unit 28 receives a user-input instruction about whether or not to use the color conversion information 14 transferred from the source device 1. If the user inputs an instruction to use the color conversion information 14 transferred from the source device 1, the creation of color conversion information 26 by the creating unit 23 is not conducted, and the transferred color conversion information 14 is used by the color converting unit 24 to conduct color conversion on the output information 13, and the converted output information is output from the image forming unit 25. Also, if the user inputs an instruction to not use the color conversion information 14 transferred from the source device 1, the creation of color conversion information 26 by the creating unit 23 is conducted, and the color conversion information 26 is used by the color converting unit 24 to conduct color conversion on the output information 13, and the converted output information is output from the image forming unit 25.

As an example of operation of the second exemplary modification, in the example of operation in FIG. 3 described in the first exemplary modification, when determining whether or not to use the transferred color conversion information 14 in S83, the presenting unit 27 presents information to the user, and the user interface unit 28 receives an instruction from the user. If the instruction from the user received by the user interface unit 28 is an instruction to use the color conversion information 14 transferred from the source device 1, the process proceeds to S84, and the transferred color conversion information 14 is used. Meanwhile, if the instruction from the user is an instruction to not use the color conversion information 14 transferred from the source device 1, the process proceeds to S74, and the color conversion information 26 may be created.

As another example of using the presenting unit 27 and the user interface unit 28 in the second exemplary modification, if various configuration information is transferred from the source device 1 as supplementary information 16, for example, the presenting unit 27 may present the configuration information to the user, and the user interface unit 28 may be configured to receive user-made changes to the configuration information. Furthermore, the user interface unit 28 may also receive various instructions from the user, such as a specification of the accuracy at which to create the color conversion information 26, or a specification of a creation method to use when creating the color conversion information 26, and the presenting unit 27 may present various information related to making such specifications.

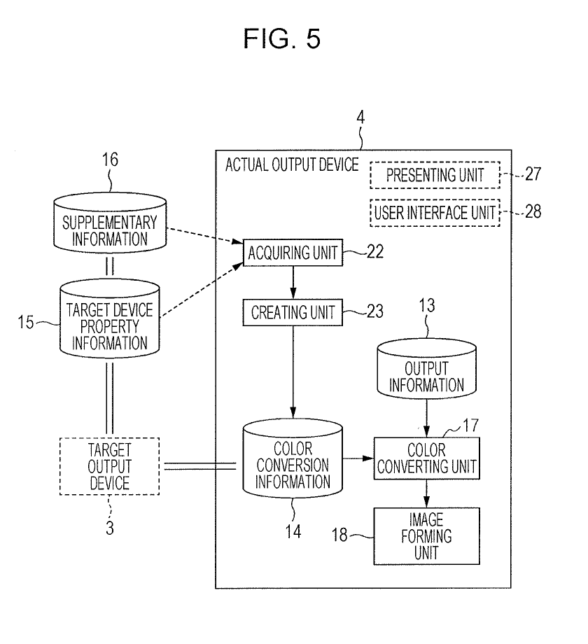

FIG. 5 is a configuration diagram illustrating a second exemplary embodiment of the present invention. FIG. 5 illustrates an actual output device 4. Otherwise, the signs in FIG. 5 are those illustrated in FIGS. 1 and 4, and duplicate description thereof may be reduced or omitted. The first exemplary embodiment describes, as an example, the case of changing the device that outputs output information created in anticipation of a certain target output device. The first exemplary embodiment illustrates an example of recreating color conversion information 14 because the characteristics of the output may differ due to differences in the device that outputs. As another example of recreating color conversion information 14, the second exemplary embodiment describes a case in which the configuration of the output device changes. Note that in the second exemplary embodiment, since the output information 13 created in anticipation of the target output device 3 is actually output on an output device that differs from the target output device 3, the device that actually outputs is designated the actual output device 4.

The configuration of the actual output device 4 may change when, for example, an expansion board for the actual output device 4 in use is purchased and installed. When an expansion board is installed, processes that were previously conducted by a circuit or software are conducted by the expansion board or by software using the expansion board, and as a result, the color processing method itself may differ, and the settings for color processing or the accuracy of computations related to color processing may differ. These changes also affect the color reproduction characteristics. Consequently, when the configuration of the actual output device 4 is changed, if color conversion is conducted using color conversion information 14 that was previously used, the reproduced colors may differ in some cases due to differences in characteristics between before and after the change of configuration. Since the output characteristics of the target output device 3 were originally being reproduced with the actual output device 4, a problem occurs if the reproduced colors differ.

Consequently, the color conversion information 14 is recreated according to the characteristics after the change of configuration.

In the second exemplary embodiment, since a transfer of information like in the first exemplary embodiment may be omitted, the functions of the transferring unit 12 and the receiving unit 21 in the configuration of the source device 1 and the destination device 2 described in the first exemplary embodiment are omitted, and an acquiring unit 22 and a creating unit 23 are included as a configuration that recreates the color conversion information 14.

The acquiring unit 22 in the second exemplary embodiment combines the function of the acquiring unit 22 and the function of the information preparing unit 11 in the first exemplary embodiment, and acquires the target device property information 15 indicating the characteristics of the target output device 3. The acquiring unit 22 may also acquire various supplementary information 16 used together with the target device property information 15 when creating the color conversion information 14. The supplementary information 16 may be various information, such as various configuration information, output method properties, paper properties, and model information or unique information of the source device 1, for example. Additionally, information such as intermediate data created during the process of creating the color conversion information 14, and a forward prediction model and reverse prediction model created from the target device property information 15, or an ICC profile created from the target device property information 15, for example, may also be acquired. This information may be acquired by reading out information stored in the current device (actual output device 4), or acquired from another device. For example, the information may be configured in a database, and acquired by searching the database.

The creating unit 23 uses target device property information acquired by the acquiring unit 22, actual device property information indicating the output characteristics of the current device (actual output device 4), and optionally supplementary information 16 acquired by the acquiring unit 22, and creates color conversion information 14 corresponding to the target output device 3 anticipated by the output information 13 in accordance with information such as configuration information. The output information 13 is created in an output color space whose components are the colors of color material used by the target output device, and the color conversion information 26 used to conduct color conversion is created in this output color space.

Note that in the case of using the supplementary information 16, the supplementary information 16 may be used as-is, or the supplementary information 16 may be modified in accordance with configuration information about the changed configuration of the actual output device 4, and converted to information compatible with the circumstances for use. Conversely, the settings of the actual output device 4 after the change of configuration may also be modified in accordance with the supplementary information 16 in some cases. When creating the color conversion information 14, the color conversion information 14 may be made to reflect not only color reproduction, but also various settings such as color material bleed adjustment and color material quantity correction.

Additionally, information such as intermediate data created during the process of creating the color conversion information 14 from before the change of configuration, and a forward prediction model and reverse prediction model created from the target device property information 15, or an ICC profile created from the target device property information 15, for example, may also be used. In the case of using such information, the time and processing load for creating the color conversion information 14 may be reduced compared to the case of not using such information.

Various established methods may be used as the method of creating the color conversion information 14, and the method used to create the color conversion information 14 from before the change of configuration may also be used. As an example, if the color space of the colors of the color material is the CMYK color space, color conversion information 14 that controls K, such as conserving K, for example, and conducts color conversion from the CMYK color space to the CMYK color space may be created. Obviously, the color conversion information 14 may be created according to the supplementary information 16 and various configured conditions. For example, various conditions may be imposed, such as control of the total quantity of color material, control of a specific color, and bleed control, for example, and the color conversion information 14 may be created in accordance with these conditions.

After the creating unit 23 recreates the color conversion information 14, the recreated color conversion information 14 is used by the color converting unit 17 to conduct color conversion on the output information 13, and the converted output information is output by the image forming unit 18.

The color conversion information 14 created by the creating unit 23 may be saved by overwriting the color conversion information 14 previously saved in association with the target output device 3. After the color conversion information 14 is created, if output information 13 anticipating the target output device 3 is transferred, the already-recreated color conversion information 14 may be used to conduct color conversion corresponding to the changed configuration.

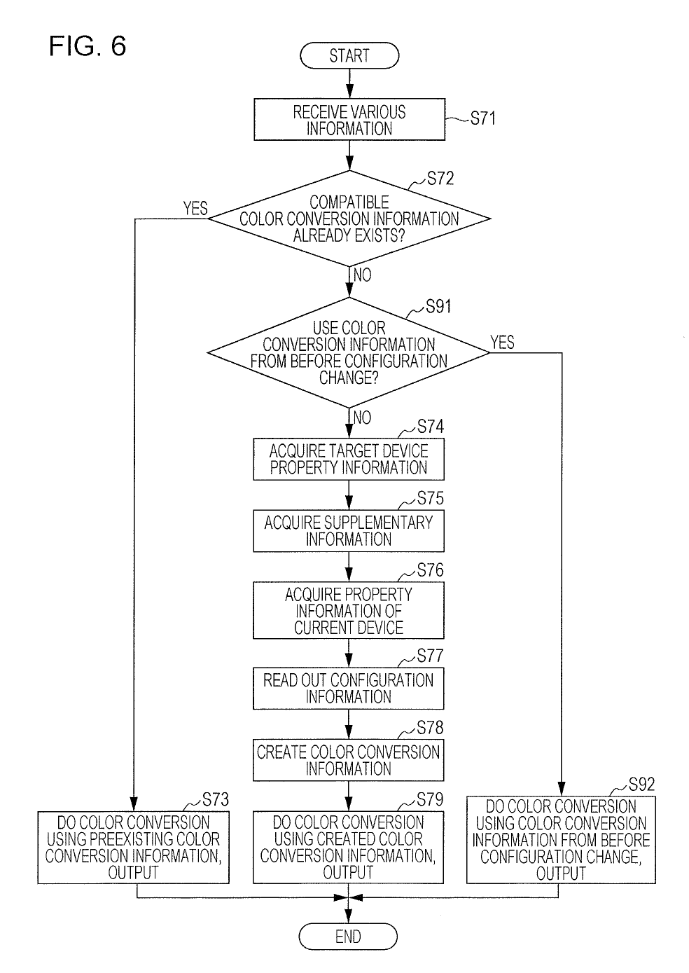

FIG. 6 is a flowchart illustrating an example of operation of an actual output device according to the second exemplary embodiment of the present invention. Of the signs for each step in the flowchart, duplicate description may be reduced or omitted for the processes labeled with signs indicated in FIGS. 2 and 3. When the configuration of the actual output device 4 is changed and output information 13 is to be output, in S71, the acquiring unit 22 acquires various information relevant to recreate color conversion information 14 that is not used when simply conducting color conversion using the color conversion information 14, such as the target device property information 15, and optionally various supplementary information 16.

In S72, it is determined whether or not color conversion information 14 corresponding to the target output device 3 anticipated by the received output information 13 already exists on the current device (actual output device 4). Obviously, since the color conversion information 14 may also differ depending on various configured conditions, such configured conditions are taken into account to judge whether or not to use already-existing color conversion information 14 corresponding to the target output device 3. For example, if there exists color conversion information 14 created when previously outputting other output information 13 after the configuration of the actual output device 4 was changed, that color conversion information 14 may be used if that color conversion information 14 corresponds to the target output device 3 (including various conditions). In this case, the process of recreating new color conversion information 14 may be omitted.

If color conversion information 14 that corresponds to the target output device 3, including configured conditions and the like, already exists, in S73, the existing color conversion information 14 corresponding to the target output device 3 is used by the color converting unit 17 to conduct color conversion, and the converted output information is output from the image forming unit 18.

If it is determined in S72 that color conversion information 14 corresponding to the target output device 3 anticipated by the output information 13 (including various conditions) does not exist, in S91, it is determined whether or not to use pre-existing color conversion information 14 from before the change of configuration. This determination may take color conversion information 14 provided in correspondence with the target output device 3 (the various conditions may differ from the current conditions in some cases), compare the characteristics of the current device (actual output device 4) when that color conversion information 14 was created to the characteristics of the current device (actual output device 4) at the present time, and determine whether or not the difference in the characteristics is within a preconfigured range. If the difference between the characteristics is within the preconfigured range, the pre-existing color conversion information 14 may be used, whereas if the difference is outside the range, new color conversion information 14 may be recreated. For example, if the configuration changes due to the installation of an expansion board, but the installed expansion board is determined in advance to not affect the output characteristics, or if the difference in output characteristics between before and after the change of configuration is within a predetermined range, it may be determined that the pre-existing color conversion information 14 from before the change in the configuration of the actual output device 4 is to be used.

Alternatively, the presenting unit 27 and the user interface unit 28 described in the second exemplary modification of the first exemplary embodiment may be provided, information about the difference in output characteristics between before and after the change in configuration of the actual output device may be presented to the user, for example, and an instruction to use the color conversion information 14 from before the change in configuration of the actual output device, or recreate the color conversion information 14, may be received from the user.

In the case of determining to use the pre-existing color conversion information 14 from before the change in configuration of the actual output device 4, the creation of color conversion information 14 by the creating unit 23 is not conducted, and in S92, the pre-existing color conversion information 14 from before the change in configuration corresponding to the target output device 3 is used by the color converting unit 17 to conduct color conversion on the output information 13, and the converted output information is output from the image forming unit 18.

Also, in the case of determining to not use the pre-existing color conversion information 14 from before the change in configuration of the actual output device 4, color conversion information 14 corresponding to the target output device 3 is recreated by the processing in S74 and thereafter. This processing is as described in the first exemplary embodiment. Described simply, in S74, the acquiring unit 22 acquires the target device property information 15. Additionally, in S75, supplementary information 16 is acquired in some cases. Additionally, in S76 the output characteristics of the current device (actual output device 4) are acquired, and in S77, various configuration information is read out, such as information about total quantities of color material, for example.

After this information is collected, in S78, the creating unit 23 uses the target device property information 15, the output characteristics of the current device (actual output device 4), various configuration information, and optionally the supplementary information 16, to recreate the color conversion information 14. In the case of using settings from before the change in configuration as the supplementary information 16, the supplementary information 16 may also be modified for use according to settings specific to the changed configuration. If the acquiring unit 22 also acquires intermediate data that was created during the process of creating the color conversion information 14 from before the change in configuration, using the intermediate data to recreate the color conversion information 14 may speed up processing compared to the case of not using the intermediate data.

In S79, the color converting unit 17 uses the color conversion information 14 created in S78 to conduct color conversion, and the converted information may be output from the image forming unit 18. The color conversion information 14 created in S78 is used to conduct color conversion so that the output characteristics of the target output device 3 are reproduced with the actual output device 4 after the change in configuration. Consequently, in S79, there is obtained output reproducing the characteristics of the target output device 3 with the actual output device 4 after the change in configuration.

During the process of outputting output information 13 after the configuration of the actual output device 4 is changed as discussed above, the user does not perform any work such as preparing the target device property information 15. In addition, mistaken operations and the like that may be produced by such work do not occur.

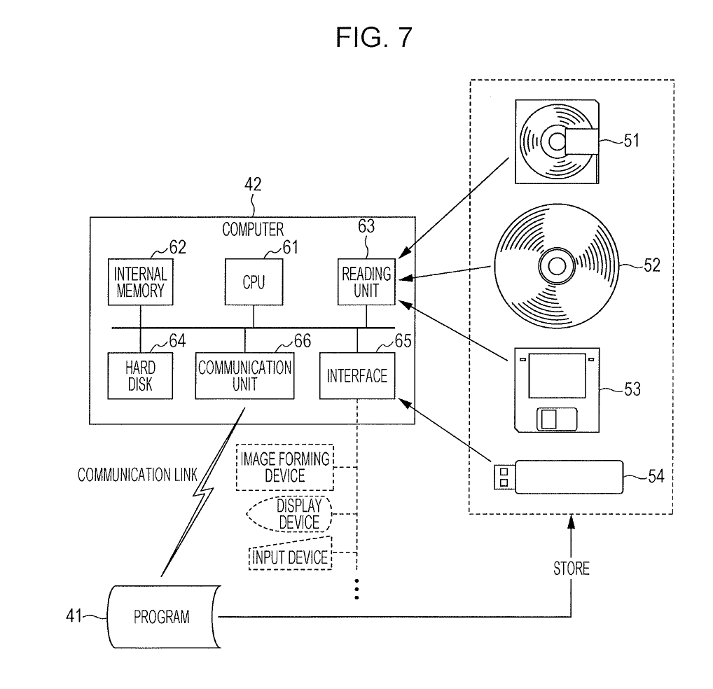

FIG. 7 is an explanatory diagram illustrating an example of a computer program, a recording medium storing the program, and a computer in the case of using a computer program to realize the functions of a device described in the exemplary embodiments of the present invention. FIG. 7 illustrates a program 41, a computer 42, a magneto-optical disc 51, an optical disc 52, a magnetic disk 53, memory 54, a CPU 61, internal memory 62, a reading unit 63, a hard disk 64, an interface 65, and a communication unit 66.

The functions of the source device 1 or destination device 2 described in the first exemplary embodiment of the present invention or the actual output device 4 described in the second exemplary embodiment discussed earlier may be fully or partially realized by a program 41 executed by a computer. In this case, the program 41 and information such as data used by the program may be stored in a storage medium readable by the computer. The storage medium induces a state change of energy such as magnetism, light, or electricity in a reading unit 63 provided as part of the hardware resources of the computer according to the stated content of the program, and transmits the stated content of the program to the reading unit 63 in the form of a signal corresponding to the state change. For example, the storage medium may be a magneto-optical disc 51, an optical disc 52 (including a CD or DVD), a magnetic disk 53, or memory 54 (including an IC card, memory card, or flash memory). Obviously, the storage medium is not limited to being portable.

The program 41 is stored in such a storage medium, and the storage medium is installed into a reading unit 63 or interface 65 of the computer 42, for example. The program 41 is read out by the computer, and stored in internal memory 62 or a hard disk 64 (including a magnetic disk or silicon disk). the program 41 is executed by the CPU 61, and the functions of the source device 1 or destination device 2 described in the first exemplary embodiment of the present invention or the actual output device 4 described in the second exemplary embodiment discussed earlier are fully or partially realized. Alternatively, the program 41 is transferred to the computer 42 via a communication link, received by the communication unit 66 in the computer 42 and stored in the internal memory 62 or the hard disk 64, and executed by the CPU 61 to realize the above functions.

Various other devices may also be connected to the computer 42 via the interface 65. For example, an image forming device corresponding to the image forming unit 18 or the image forming unit 25 may be connected. Furthermore, devices such as a display device used by the presenting unit 27 to present information to the user, or an instruction device that accepts an instruction from the user received by the user interface unit 28, may be connected. Various other types of devices may also be connected via the interface 65. Note that the respective structural elements are not limited to operating on a single computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An output processing system comprising:
a source device including at least one hardware processor and a storage medium storing executable instructions that cause the hardware processor to:
transfer output information representing an image to be output created in anticipation of a target output device in an output color space whose components are colors of a color material used to form the output on the target output device, together with target device property information indicating characteristics of the target output device to a destination device; and
the destination device including at least one hardware processor and a storage medium storing executable instructions that cause the hardware processor to:
receive the output information and the target device property information transferred from the source device,
create color conversion information from the target device property information and actual device property information indicating characteristics of the destination device itself, and
conduct color conversion of the output information.

2. The output processing system according to claim 1, wherein
the source device is additionally configured to transfer, together with the output information, supplementary information used together with the target device property information to create color conversion information which is provided in correspondence with the target output device and which conducts color conversion in the output color space, and
the destination device is further configured to create the color conversion information by referencing the transferred output information and the supplementary information.

3. The output processing system according to claim 2, wherein
the destination device creates the color conversion information by modifying the supplementary information in accordance with configuration information used to create color conversion information on the destination device itself.

4. The output processing system according to claim 2, wherein
the source device is additionally configured to transfer, together with the output information, color conversion information which is provided in correspondence with the target output device and which conducts color conversion in the output color space, and
the destination device is further configured to recreate the color conversion information if color conversion characteristics according to the received color conversion information are incompatible with the destination device itself.

5. The output processing system according to claim 3, wherein
the source device is additionally configured to transfer, together with the output information, color conversion information which is provided in correspondence with the target output device and which conducts color conversion in the output color space, and
the destination device is further configured to recreate the color conversion information if color conversion characteristics according to the received color conversion information are incompatible with the destination device itself.

6. The output processing system according to claim 4, wherein
the source device transfers source device property information indicating characteristics of the source device together with the output information, and
the destination device recreates the color conversion information if a difference between characteristics of the source device indicating by the transferred source device property information and characteristics of the destination device itself falls outside a preconfigured range.

7. The output processing system according to claim 4, wherein
the source device transfers source device property information indicating characteristics of the source device together with the output information, and
the destination device presents information of a difference between characteristics of the source device indicating by the transferred source device property information and characteristics of the destination device itself, and following a received instruction, uses the color conversion information transferred from the source device, or recreates the color conversion information.

8. The output processing system according to claim 1, wherein
if color conversion information created according to a creation condition of the color conversion information obtained from information accompanying the output information already exists, the destination device uses the existing color conversion information.

9. An output processing system comprising:
a source device including at least one hardware processor and a storage medium storing executable instructions that cause the hardware processor to:
prepares target device property information indicating characteristics of a target output device, and transfer output information representing an image to be output created in anticipation of the target output device in an output color space whose components are colors of a color material used to form the output on the target output device, together with the target device property information to a destination device; and
the destination device including at least one hardware processor and a storage medium storing executable instructions that cause the hardware processor to:
receive information transferred from the source device, acquire the target device property information from information received by the receiving unit, create, from the target device property information and actual device property information indicating characteristics of the destination device itself, color conversion information used to conduct color conversion so that color reproduction of the target output device is conducted with the destination device itself, and use color conversion information created by the creating unit to conduct color conversion on the output information created in anticipation of the target output device and transferred from the source device, so that color reproduction of the target output device is conducted with the destination device itself.

10. An output processing device comprising:
at least one hardware processor and a storage medium storing executable instructions that cause the hardware processor to:
acquire, when outputting output information representing an image to be output created in anticipation of a target output device in an output color space whose components are colors of a color material used to form the output on the target output device, target device property information indicating characteristics of the target output device, if color conversion information which is provided in correspondence with the target output device and which conducts color conversion in the output color space is incompatible with characteristics of an actual output device; and
recreate color conversion information using the target device property information and actual device property information indicating characteristics of the actual output device.

11. The output processing device according to claim 10, wherein
the color conversion information is created by additionally using supplementary information used together with the target device property information to create the color conversion information corresponding to the target output device.

12. The output processing device according to claim 11, wherein
the color conversion information is created by modifying the supplementary information in accordance with configuration information.

13. The output processing device according to claim 10, wherein
the target device property information is acquired and the color conversion information is recreated if a difference between characteristics of an actual output device when the color conversion information provided in correspondence with the target output device was created and characteristics of a current actual output device falls outside a preconfigured range.

14. The output processing device according to claim 11, wherein
the target device property information is acquired and the color conversion information is recreated if a difference between characteristics of an actual output device when the color conversion information provided in correspondence with the target output device was created and characteristics of a current actual output device falls outside a preconfigured range.

15. The output processing device according to claim 12, wherein
the target device property information is acquired and the color conversion information is recreated if a difference between characteristics of an actual output device when the color conversion information provided in correspondence with the target output device was created and characteristics of a current actual output device falls outside a preconfigured range.

16. The output processing device according to claim 10, wherein the executable instructions further cause the hardware processor to:
present information of a difference between characteristics of an actual output device when the color conversion information provided in correspondence with the target output device was created and characteristics of a current actual output device; and
receive an instruction indicating whether or not to use the color conversion information provided in correspondence with the target output device;
wherein if an instruction to not use the color conversion information is received, the color conversion information is treated as incompatible with the characteristics of the actual output device, the target device property information is acquired, and the color conversion information is recreated.

17. The output processing device according to claim 11, wherein the executable instructions further cause the hardware processor to:
present information of a difference between characteristics of an actual output device when the color conversion information provided in correspondence with the target output device was created and characteristics of a current actual output device; and
receive an instruction indicating whether or not to use the color conversion information provided in correspondence with the target output device;
wherein if an instruction to not use the color conversion information is received, the color conversion information is treated as incompatible with the characteristics of the actual output device, the target device property information is acquired, and the color conversion information is recreated.

18. The output processing device according to claim 12, wherein the executable instructions further cause the hardware processor to:
present information of a difference between characteristics of an actual output device when the color conversion information provided in correspondence with the target output device was created and characteristics of a current actual output device; and
receive an instruction indicating whether or not to use the color conversion information provided in correspondence with the target output device;
wherein if an instruction to not use the color conversion information is received, the color conversion information is treated as incompatible with the characteristics of the actual output device, the target device property information is acquired, and the color conversion information is recreated.

19. A non-transitory computer-readable medium storing a program causing a computer to execute a process for executing a function of the output processing device according to claim 10, the process comprising:
acquiring, when outputting output information created in anticipation of a target output device in an output color space whose components are colors of color material, target device property information indicating characteristics of the target output device, if color conversion information which is provided in correspondence with the target output device and which conducts color conversion in the output color space is incompatible with characteristics of an actual output device; and
recreating color conversion information from the target device property information and actual device property information indicating characteristics of the actual output device.
